(19) United States
(12) Patent Application Publication
(10) Pub. No.: US 2026/0348213 A1
(43) Pub. Date: Nov. 5, 2026

(54) ADJUSTABLE DEVICE FOR RESTORING THE PARALLELISM BETWEEN SLIDING CABINET DOORS

(71) Applicant: TERNO SCORREVOLI S.P.A. UNIPERSONALE, Varedo (IT)

(72) Inventors: Giovanni TERNO, Varedo (IT); Emanuele MENI, Varedo (IT)

(21) Appl. No.: 18/997,556

(22) PCT Filed: Jun. 19, 2023
(86) PCT No.: PCT/EP2023/025285

§ 371 Date: Jan. 22, 2025

(30) Foreign Application Priority Data
Jul. 27, 2022 (IT) 102022000015864

(51) Int. Cl. E05D 15/06; E05D 15/08

(52) U.S. Cl. CPC E05D 15/0656; E05D 15/08; E05Y 2201/48; E05Y 2201/682; E05Y 2201/688; E05Y 2201/702; E05Y 2600/12; E05Y 2900/20

(57) ABSTRACT

An adjustable device (10), (10′) for restoring the parallelism between internal (12) and external (14) sliding doors starting from the lower part of cabinets (16) comprises a wheel (24) for sliding the device itself along an extruded profile (60) and a steel elastic lamina spring (26); the sliding wheel (24) is fixed with a knurled pin (28) to a central support (30) from the opposite sides of which a pair of pins (32) protrudes, aligned horizontally between them. On the sides of the central support (30) respective side supports (34, 36) are arranged in which is housed, without possibility of longitudinal excursion, a worm screw (54) cooperating with an insert (48) arranged in the same side supports (34, 36), provided laterally with a hole (56) for a handling key (58) of said screw (54).

The present invention relates to an adjustable device or rail for restoring parallelism between sliding cabinet doors.

More specifically, the present invention relates to a device suitable for realizing proper alignment between the front face of sliding doors arranged outside the body of cabinets, and the front face of the body itself, so as to ensure parallelism between the two surfaces. Several solutions intended for cabinets with sliding doors, overlapping each other and external to the body of the cabinets themselves, are known. These are apparatuses comprising multiple elements, including sliding carriages fixed above the upper shelf, from which the doors are hung; there are also rails, with associated sliding profiles, placed under the lower shelf of the body of the cabinets. The latter rails or lower rails do not support the weight of the doors but have the function of properly spacing the doors from the front face of the shelf itself; stops and dampers are also provided to brake and position the doors at their respective end-strokes. The device of the present invention expressly relates to an adjustable rail intended for the lower part of cabinets for the purpose of achieving the precise alignment of sliding doors and, as noted above, to enable parallelism between the last said and the front of the cabinet; this parallelism, which is essential for the optimal aesthetic appearance of the finished product and indispensable for the proper functioning of all sliding accessories, is frequently only theoretical due to defects in the construction of the cabinet body and sliding doors or related to manufacturing tolerances inherent in the upper sliding elements and the lower rails.

It should also be noted that the upper sliding elements have different sizes, because they must override the internal doors, which can have varying thicknesses; the thickness is also changeable in relation to the external door, so the weight of the doors themselves is also variable. The heavier weight results in an outward bending of the cabinet of the upper slide; conversely, heavier the door, greater the push of the lower slide toward the inside of the cabinet.

This difference between upper bending and lower push determines the inclination of the external door, which will turn out not to be parallel to the internal one and, consequently, not even to the cabinet body. Here, then, is the need to provide adjustable bottom rails, suitable for restoring the parallelism of the doors with each other and with respect to the cabinet body.

A solution concerning an adjustable bottom rail that is moved by means of a slider with a beveled end to vertically adjust the tilt angle of the sliding door is known from WO 2019/057591. At the time of adjustment, the inconvenience manifests itself in this solution due to the need to make the adjustment by inserting the hands below the door, in a small space that makes the adjustment itself difficult.

In German Utility Model No. DE 202 14 907, a solution is described concerning a device suitable for the adjustable connection of cabinet doors through a knob coupled with a groove and provided with clamping means once the desired position is achieved.

EP 3 910 144 refers to a carriage for correcting the inclination of sliding cabinet doors; a slide is provided that has the ability to perform both a lateral inclined movement and the sliding of its ends of respective clamps. These are, in general, structurally complex solutions that include a significant number of components to be fabricated and assembled.

According to IT 222698, in a carriage that can be associated with the lower or upper edge of a sliding door leaf, there is a support with a small wheel that can rotate around its axis to engage the corresponding sliding rail through the action of a leaf spring. The purpose of the present invention is to overcome the drawbacks complained of above.

More specifically, it is the purpose of the present invention to provide an adjustable device for restoring the parallelism between sliding cabinet doors that is capable of allowing adjustments to be made smoothly, avoiding the need for the operator to insert his hands and necessary tools below the door.

A further purpose of the invention is to provide a device as defined above capable of allowing multiple adjustment, i.e., from both sides under the conditions of greater misalignment, with the added advantage of not requiring the construction of a right and a left version.

A further purpose of the invention is to make available to users an adjustable device that can guarantee a high level of strength and reliability over time, such, moreover, that can be easily and economically made.

These and other purposes are achieved by the adjustable device of the invention for restoring the parallelism between sliding cabinet doors according to the main claim.

The construction and functional characteristics of adjustable device of the present invention will be more clearly comprehensible from the detailed description below in which reference is made to the appended drawings which show a preferred and non-limiting embodiment and wherein:

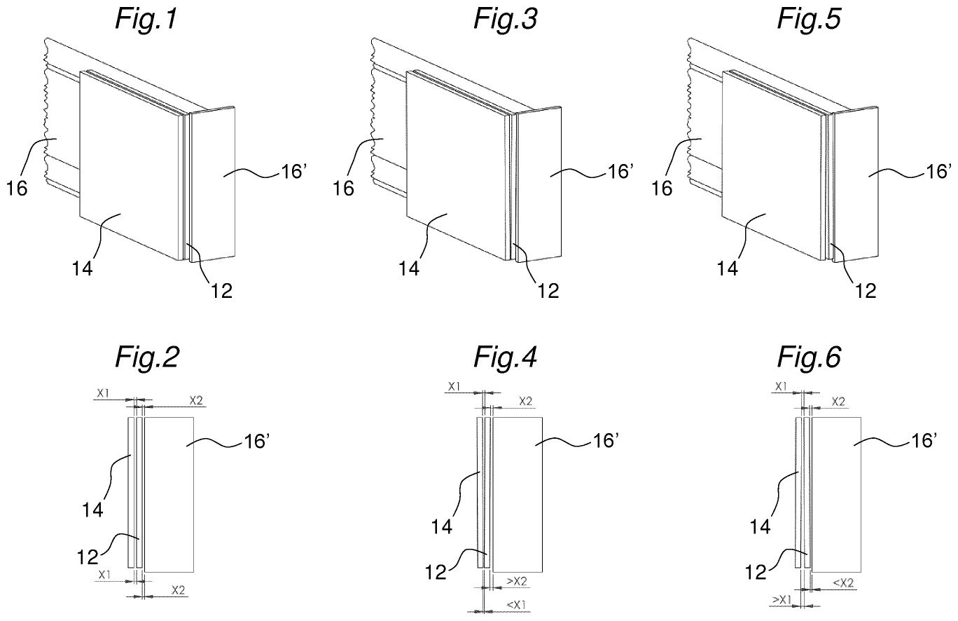

FIG. 1 schematically shows a partial axonometric view of a cabinet with a pair of perfectly aligned sliding doors;

FIG. 2 schematically shows a side view of the cabinet in FIG. 1;

FIGS. 3 and 4 schematically show, respectively in partial and side axonometric views, a cabinet in which the internal door is misaligned at the bottom compared with the external door;

FIGS. 5 and 6 schematically show, respectively, in partial and side axonometric views, a cabinet in which the external door is misaligned at the bottom in relation to the internal door;

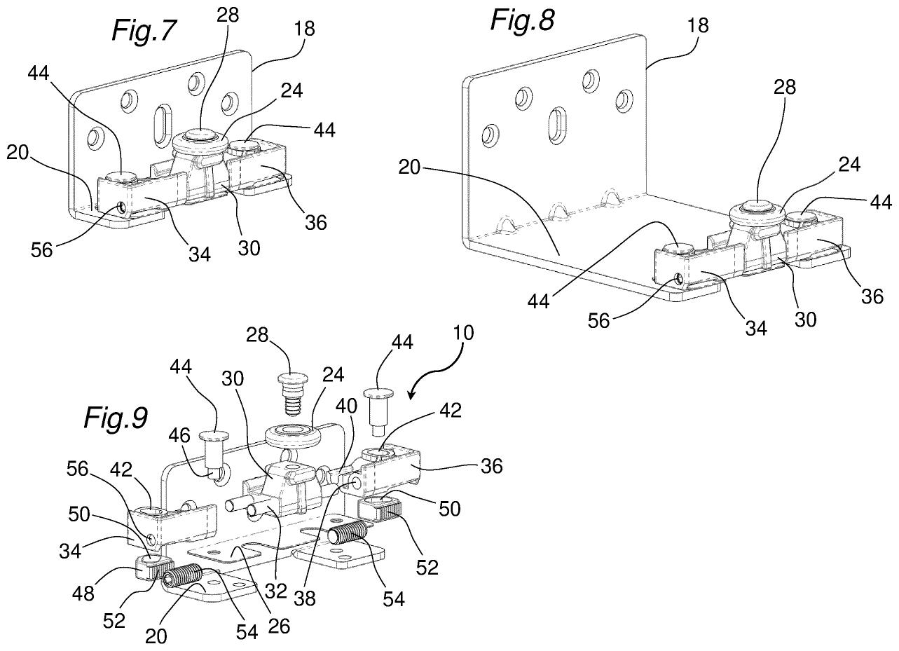

FIG. 7 schematically shows an axonometric view of the adjustable device of the invention in which the metal support structure is sized for the internal door;

FIG. 8 schematically shows an axonometric view of the adjustable device of the invention in which the metal support structure is sized to surmount the thickness of the internal door;

FIG. 9 schematically shows an exploded view of the adjustable device of the invention;

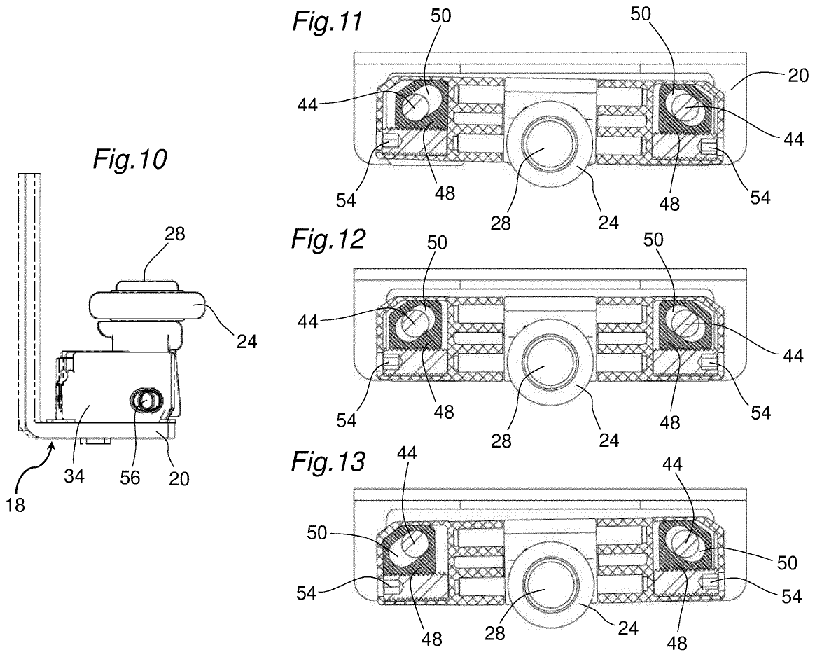

FIG. 10 schematically shows, in side view, the device of the invention in which the sliding wheel is folded upward in the working position;

FIGS. 11, 12 and 13 schematically show, in view from the top, as many adjustment positions of the same device;

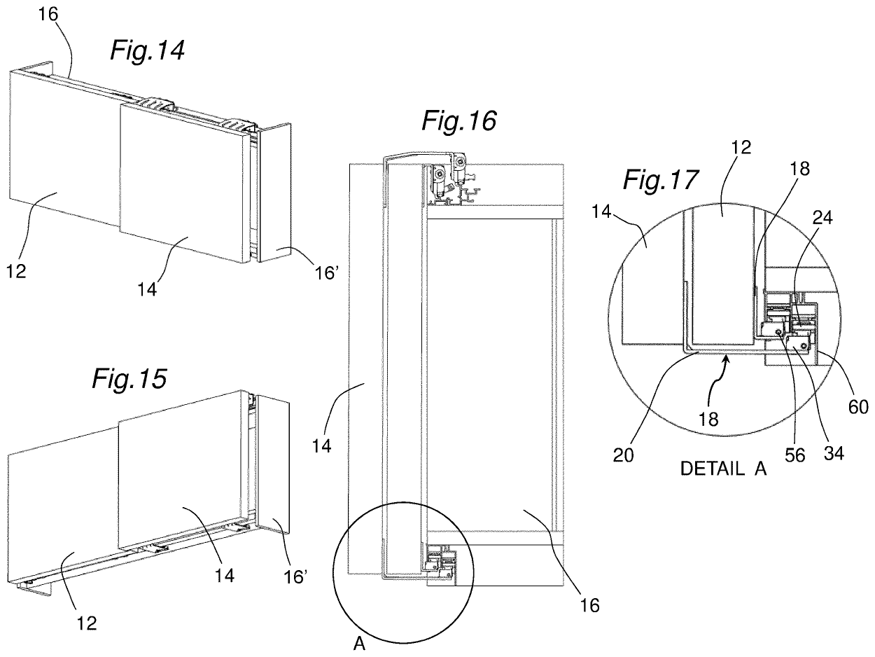

FIGS. 14 and 15 schematically show, respectively, in view from the front and the back, a part of the cabinet to evidence the position of two sliding doors in the closed position;

FIG. 16 schematically shows, in partial longitudinal section, the cabinet in which both doors are hung to the cabinet structure;

FIG. 17 show the enlargement of detail “A” in FIG. 16;

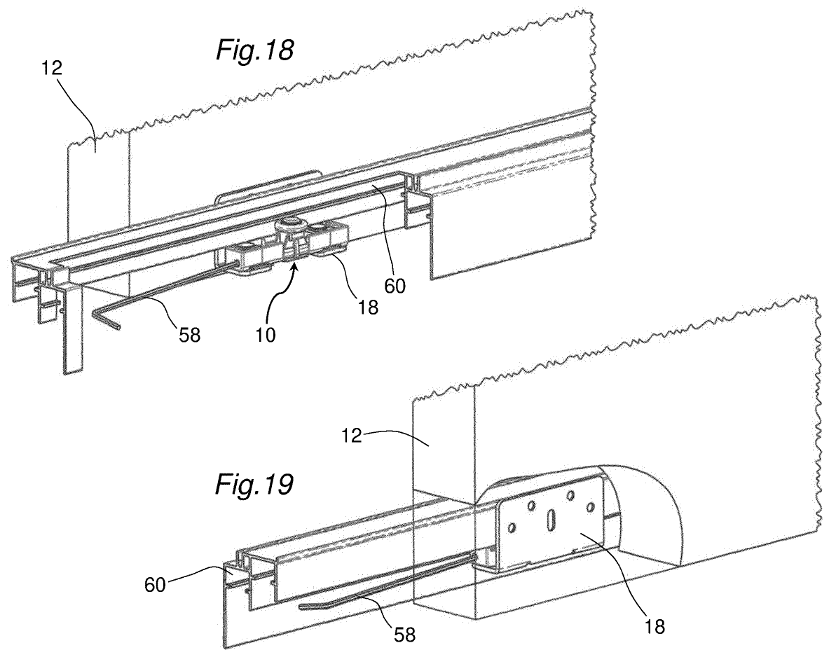

FIGS. 18 and 19 schematically show, respectively, in view from the front and the back, the device of the invention in the working position and the related means of adjustment acting on opposite sides;

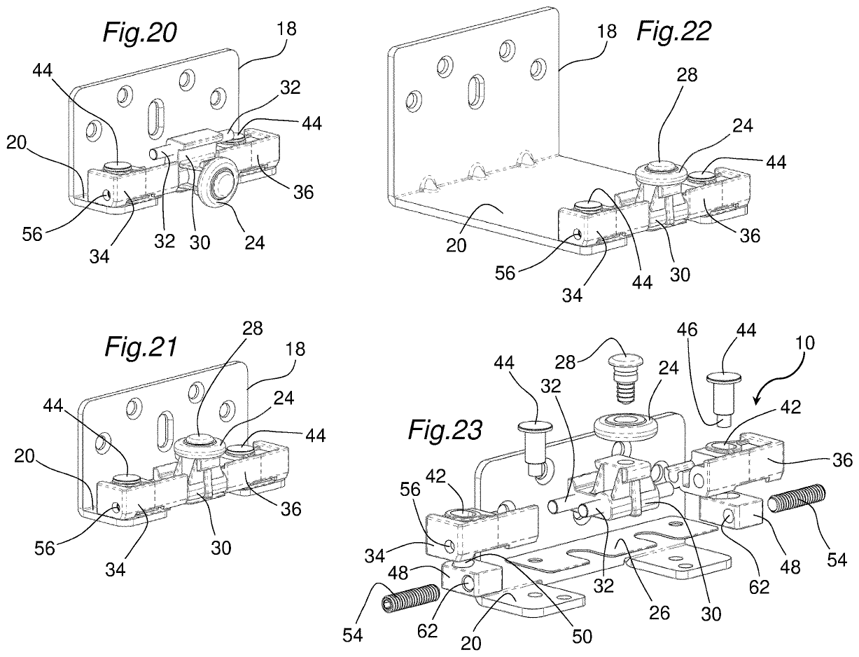

FIG. 20 schematically shows an axonometric view of the adjustable device of the invention according to an alternative embodiment, in which the sliding is tilted forward in the door mounting position;

FIG. 21 schematically shows an axonometric view of the adjustable device of the invention according to FIG. 20, in which the axis of rotation of the sliding wheel is in the vertical position, that is in the working position;

FIG. 22 schematically shows an axonometric view of the adjustable device of the invention combined with a metal support structure sized for the external door;

FIG. 23 schematically shows an exploded view of the device of the invention according to the alternative embodiment shown in FIGS. 20, 21 and 22.

The initial reference is to Figures from 1 to 6, which illustrate the various alignment/misalignment conditions of the sliding cabinet doors. In particular, FIGS. 1 and 2 show the situation in which the internal 12 and external 14 sliding doors of the body of a cabinet 16 are perfectly aligned, parallel to each other; the distance X1 between them and the distance X2 between the internal 12 door and the sidewall 16′ of the cabinet 16 are constant for the entire height. In FIGS. 3 and 4, on the other hand, a first type of misalignment is detected in that, in the lower part, external 14 door turns out to be more closely drawn to the internal 12 door, and the distance X1 between them is less than the distance X2 that exists between internal 12 door and sidewall 16′ of the cabinet 16; therefore, the two doors 12 and 14 are not parallel to each other. In FIGS. 5 and 6, lastly, a second type of misalignment is found instead in that, at the bottom, internal 12 door is more closely aligned with sidewall 16′ of cabinet 16 and the X2 distance existing between them is less than the X1 distance existing between said doors 12 and 14, which again are not parallel to each other.

In order to restore parallelism between the same doors 12, 14 with each other and with respect to the body of a cabinet 16, the device of the present invention was thought up, shown as a whole with 10 in FIG. 9 illustrating it in exploded view. Said device 10 is fixed to an angular plate 18, specifically at the front edge of the horizontally developed base 20 of the plate itself; the fixing, as further specified below, is made by means of conventional rivets 44. The base 20 of the angular plate 18 appears to be more or less extended depending on use of the device 10 for internal 12 doors or for external 14 doors; at FIGS. 7 and 8 said base 20 has a limited extension in depth as it is intended to be fixed to internal 12 doors, while at FIG. 8 the base 20 of the angular plate 18 appears to be more extended in depth as it is intended to be attached to external 14 doors and thus having to surmount the thickness of the internal 12 doors. Such configurations of the angular plate 18 fixed to the respective doors 12 and 14 can be noted, in particular, from FIG. 17. The device 10 comprises a sliding wheel 24 and a steel elastic lamina spring 26 that has the function of orienting the wheel itself in the mounting position, i.e., tilted forward (as shown in FIG. 20) or in the working position, i.e., with the axis of rotation in the vertical position, as illustrated, for example, in FIGS. 7, 8 and 10.

According to the invention, the sliding wheel 24 is fixed with a knurled pin 28 to a central support 30, from the opposite sides of which a pair of pins 32, aligned horizontally with each other; on the sides of the central support 30 are arranged respective side supports 34, 36, of irregular prismatic shape, which on the side facing the central support 30 have a hole 38 and an adjacent concave seat 40, substantially semi-circular. The first of these pins is arranged to fit into the hole 38 of side supports 34, 36, while the second, which is closer to the vertical wall of the angular plate 18, is intended to strike the concave seat 40 of the same side supports, which partially define a housing for the components indicated in the following. Said side supports 34, 36 are provided with a vertically developed through slot 42, into which is inserted a rivet 44 whose end part 46 has a reduced diameter with respect to the rest of the stem. The rivet 44 also crosses an insert 48, on which a diagonally extended through slot 50 is made; insert 48 is housed in each of the side supports 34, 36 and, in an embodiment, comprises a series of vertical reliefs forming a toothing 52. In the side supports 34, 36, on the side with respect to the insert 48, a worm screw 54 is arranged; said worm screw is positioned frontally with respect to the toothing 52, in an obligatory seat in which it has no possibility of excursion in the longitudinal direction. The worm screw 54 can be moved in rotation with a hexagonal key 58 from its hexagon socket end and thus serves as a worm screw since its thread engages precisely with the toothing 52 of the insert 48; the key 58 is advantageously insertable from the side of each of the side supports 34, 36, which are for the purpose provided with an access hole 56, as detailed by FIGS. 18 and 19. The rivets 44 pass through side supports 34, 36 and the elastic lamina spring 26, making all these elements integral on the base 20 of the angular plate 18; the reduced-diameter end part 46 of the rivets 44 aligns said steel elastic lamina spring with the respective holes cut in the base 20 and rests on said spring. The middle part of the rivets 44 is of equivalent height to side supports 34, 36, increased by the clearance necessary to allow them to slide, engages in slot 42 of side supports 34, 36 and slot 50 of the adjustment inserts 48, connecting them to each other.

The device 10 fixed to the horizontal base 20 of the angular plate 18 is made integral, from the vertical wall of the same corner plate, to the cabinet door 12 or 14, as shown in FIGS. 14 to 16 and, most importantly, in FIG. 17; sliding wheels 24 are in the working position, that is with the axis of rotation in the vertical position, and slide in the respective seat of a known extruded profile in itself, indicated by 60 in FIG. 17. Having to proceed with the verticality realignment of a door, in order to make the air between the two internal 12 and external 14 doors uniform for the entire height, i.e., between the upper and lower parts of the doors themselves, the worm screw 54 attested in the side supports 34, 36 without the possibility of excursion in the longitudinal direction is operated with the key 58; said worm screw, the thread of which engages precisely with the toothing 52 of insert 48, thus moves the insert itself and the respective side supports 34, 36 and the rivet 44 thus has faculty for excursion along slot 42 of the same supports and along the slot 50 of the adjusting inserts 48. The induced movement causes the whole device 10 and the door connected to it to move forward or backward to the point where realignment is realized. Maximum adjustment is achieved by acting on the worm screw 54 on both sides of device 10, an operation that occurs only under conditions of greater misalignment; under standard conditions, acting on only one side is sufficient.

FIGS. 11, 12 and 13 schematically show the effect of the adjustments; FIG. 12 refers to a condition of perfect alignment; head of the rivets 44 is located in the center of the slot 50 of adjustment inserts 48. FIGS. 11 and 13, on the other hand, schematize the modified positioning of the head of the rivets 44, which is not in the center of the slot 50 of adjustment inserts 48 but is totally off-center upward or downward in the slot itself, signifying that a door realignment operation was necessary. The extension of the slot 42 and the slot 50 determines the possibility of excursion of side supports 34, 36 with respect to the vertical wall of the angular plate 18.

FIGS. 20 to 23 refer to an alternative and preferred embodiment of the device of the invention, indicated a whole by 10′ in FIG. 23. According to this embodiment, in which the same numerical references are used as in the previous one as to common components, the worm screw 54 is inserted directly into a threaded hole 62 obtained in the insert 48; also in this hypothesis, the key 58 is used to operate on the worm screw 54, which is attested in the side supports 34, 36 without the possibility of longitudinal excursion. Insert 48 lacks toothing 52, which was present in the previous version. Turning said screw 54, which operates as an endless screw, again has the effect of moving the side supports 34, 36 with respect to the vertical wall of the angular plate 18.

As it can be noted from the above, the advantages that the invention achieves are obvious. The device of the invention allows the precise alignment of the internal 12 sliding doors and external 14 sliding doors at the bottom of the cabinets 16 to be made, and the adjustment is made smoothly, avoiding the need for the operator to insert his hands and necessary tools below the doors themselves. Further advantageous is the ability to intervene on either side of the device 10 in conditions of greater misalignment.

Despite the invention having been described above with particular reference to two of its preferred embodiments, made solely by way of a non-limiting example, numerous modifications and variants will appear evident to a person skilled in the art in the light of the above description. The present invention therefore sets out to embrace all the modifications and variants which fall within the scope of the following claims.

1. An adjustable device for restoring the parallelism between internal and external sliding doors starting from the lower part of cabinets comprising a wheel for sliding the device itself along an extruded profile and a steel elastic lamina spring, which has the function of orienting the wheel in the mounting position, that is tilted forward or in the working position, with the axis of rotation in the vertical position, wherein the sliding wheel is fixed with a knurled pin to a central support from the opposite sides of which a pair of pins protrudes, aligned with each other horizontally, on the sides of the central support respective side supports being arranged in which it is housed, without possibility of longitudinal excursion, a worm screw cooperating with an insert arranged in the same side supports provided laterally with a hole for a handling key of said screw.

2. The device according to claim 1, wherein the worm screw is arranged in a threaded hole of the insert in alignment with the hole.

3) The device according to claim 1, wherein the worm screw housed in the side supports without possibility of longitudinal excursion cooperates with the insert comprising a series of vertical reliefs forming a toothing facing said worm screw.

4. The device according to claim 1, wherein the side supports are provided with a through slot with vertical extension, in which a rivet is inserted whose end part has a reduced diameter with respect to the rest of the stem.

5. The device according to claim 4, wherein the rivet crosses the insert, on which a diagonally extended through slot is made, the side supports and the elastic lamina spring fixing them on the base of an angular plate in turn constrained to the internal and external doors.

6. The device according to claim 1, wherein the side supports are provided, on the part facing the central support with a hole in which one of the pins abuts and an adjacent concave seat intended to be abutted on the other of the pins.

7. The device according to claim 5, wherein the part of the larger diameter stem of the rivets defines a height equivalent to that of the side supports and engages in the slot made thereon as well as in said slot of the adjustment inserts.
